(19) United States
(12) Patent Application Publication
(10) Pub. No.: US 2026/0193984 A1
(43) Pub. Date: Jul. 9, 2026

(54) PLACER RECOVERY OF PARTICLES AND RELATED SYSTEMS, METHODS, AND DEVICES

(71) Applicant: Jerry Pledger, West Jordan, UT (US)

(72) Inventor: Jerry Pledger, West Jordan, UT (US)

(21) Appl. No.: 19/009,715

(22) Filed: Jan. 3, 2025

(51) Int. Cl. E21C 50/00; B01D 29/11

(52) U.S. Cl. CPC E21C 50/00; B01D 29/118

(57) ABSTRACT

Placer recovery systems, material collection devices, and related methods are disclosed. A placer recovery system includes a material intake device and a material collection device configured to receive material and fluid from the material intake device. The material collection device includes a filter tube and a collector. The collector is secured to a plurality of annular structures spaced along the filter tube to maintain the collector in a substantially horizontal orientation under the filter tube regardless of an orientation of the material collection device.

### TECHNICAL FIELD

This disclosure relates generally to placer recovery of particles in a stream, and more specifically to recovery of particles that are heavier than other particles in a stream.

### BACKGROUND

Materials such as precious metals (e.g., gold) may accumulate in stream or river beds. Given the high value of precious metals, profit may be obtained from harvesting materials from stream or river beds.

### BRIEF DESCRIPTION OF THE DRAWINGS

While this disclosure concludes with claims particularly pointing out and distinctly claiming specific embodiments, various features and advantages of embodiments within the scope of this disclosure may be more readily ascertained from the following description when read in conjunction with the accompanying drawings, in which:

FIG. 1 is a side view of a placer recovery system, according to some embodiments;

FIG. 2 is a side view of a material collection device, which is an example of a material collection device of the placer recovery system of FIG. 1, according to some embodiments;

FIG. 3 is a side view of a portion of a filter tube of the material collection device of FIG. 2, according to some embodiments;

FIG. 4 is a zoomed-in side view of a sub-portion of the filter tube of FIG. 3;

FIG. 5A illustrates a top view of the collector within the shell of the material collection device of FIG. 2, according to some embodiments;

FIG. 5B illustrates a bottom view of the collector within the shell of the material collection device of FIG. 2, according to some embodiments;

FIG. 6 is a side view of a material collection device, which is another example of a material collection device of the placer recovery system of FIG. 1, according to some embodiments;

FIG. 7 illustrates an example of one of the annular structures of FIG. 6 positioned in a recess in the outer surface of the filter tube;

FIG. 8 is a front view of an example of a portion of the material collection device of FIG. 6;

FIG. 9 is a front view of another example of a portion of the material collection device of FIG. 6.

FIG. 10A and FIG. 10B are side views of another example of a material collection device including a hinged collector;

FIG. 11 illustrates an inlet end and an outlet end of the material collection device of FIG. 1, according to some embodiments;

FIG. 12 is a material intake device, which is an example of a material intake device of FIG. 1, according to some embodiments;

FIG. 13A illustrates a side view of a dislodging tool, according to some embodiments;

FIG. 13B illustrates a bottom view of the dislodging tool, according to some embodiments;

FIG. 14 is another example of a material intake device, which may be used as a material intake device of the placer recovery system of FIG. 1;

FIG. 15A, FIG. 15B, and FIG. 15C are side views of the gated splitter of the material intake device of FIG. 14;

FIG. 16 is a side view of another example of a material collection device.

FIG. 17 is simplified side view of a portion of a filter tube, which is an example of a filter tube of the material collection device of FIG. 16;

FIG. 18 is a side view of a placer recovery system, which is an example of the placer recovery system of FIG. 1 implementing a water pump;

FIG. 19 is a flowchart illustrating a method of operating a placer recovery system, according to some embodiments; and

FIG. 20 is a flowchart illustrating another method of operating a placer recovery system, according to some embodiments.

### DETAILED DESCRIPTION

In the following detailed description, reference is made to the accompanying drawings, which form a part hereof, and in which are shown, by way of illustration, specific examples of embodiments in which the present disclosure may be practiced. These embodiments are described in sufficient detail to enable a person of ordinary skill in the art to practice the present disclosure. However, other embodiments enabled herein may be utilized, and structural, material, and process changes may be made without departing from the scope of the disclosure.

The illustrations presented herein are not meant to be actual views of any particular method, system, device, or structure, but are merely idealized representations that are employed to describe the embodiments of the present disclosure. In some instances, similar structures or components in the various drawings may retain the same or similar numbering for the convenience of the reader; however, the similarity in numbering does not necessarily mean that the structures or components are identical in size, composition, configuration, or any other property.

The following description may include examples to help enable one of ordinary skill in the art to practice the disclosed embodiments. The use of the terms “exemplary,” “by example,” and “for example,” means that the related description is explanatory, and though the scope of the disclosure is intended to encompass the examples and legal equivalents, the use of such terms is not intended to limit the scope of an embodiment or this disclosure to the specified components, steps, features, functions, or the like.

It will be readily understood that the components of the embodiments as generally described herein and illustrated in the drawings could be arranged and designed in a wide variety of different configurations. Thus, the following description of various embodiments is not intended to limit the scope of the present disclosure, but is merely representative of various embodiments. While the various aspects of the embodiments may be presented in the drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations, and the like, have been omitted where such details are not necessary to obtain a complete understanding of the present disclosure and are within the abilities of persons of ordinary skill in the relevant art.

The embodiments may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a function, a procedure, other structure, or combinations thereof.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may include one or more elements.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

As used herein, the phrases “substantially horizontal” or “at least substantially horizontal,” when used with reference to an orientation of a collector, refers to an orientation that is horizontal enough to maintain particles on an upper surface of the collector. “Substantially horizontal” and “at least substantially horizontal” orientations of the collector may include slanted orientations of the collected, even up to 8% to 15% grade slants.

Recovery of materials from stream or river beds may involve a great deal of work in treacherous conditions, which may result in injury or even death to individuals harvesting the materials, and may result in damage or destruction to equipment and other property. Also, given an often small proportion of desired materials in stream or river beds compared to larger proportions of undesired or worthless materials, it may be difficult to harvest a sufficient amount of desired materials to make the recovery process worthwhile.

Disclosed herein are material collection devices, placer recovery systems, and related methods that facilitate recovery of desired materials from stream or river beds. Embodiments herein improve safety to individuals harvesting the materials, reduce the probability of damage to equipment, and quickly and easily collect heavy materials such as gold from undesired or worthless materials.

In some embodiments a material collection device includes a filter tube and a collector positioned below the filter tube. The filter tube includes a wall defining apertures, an inlet through which fluid and material enter the filter tube, protrusions extending inwardly from the wall of the filter tube, and an outlet through which the fluid and the material exit the filter tube. The protrusions are in front of the apertures from a perspective of the inlet. The collector is configured to collect particles of the material that exit the filter tube through the apertures.

In some embodiments a placer recovery system includes a material collection device, a material intake device, and a material transmission device. The material collection device includes a filter tube extending therethrough and a collector positioned below the filter tube. The filter tube includes apertures and protrusions in front of the apertures from a perspective of an inlet of the filter tube. The material intake device intakes material from a streambed and fluid from the stream. The material transmission device delivers the material and fluid from the material intake device to the material collection device.

In some embodiments a method of operating a placer recovery system includes intaking, by a material intake device, material from a streambed and fluid from a stream and delivering the material and the fluid from the material intake device to a material collection device. The method also includes collecting first particles on a collector of the material collection device, the first particles sufficiently dense to exit a filter tube through one or more apertures having protrusions in front of the one or more apertures.

In some embodiments, a material collection device includes a filter tube, a plurality of annular structures spaced along the filter tube, a collector secured to the plurality of annular structures below the filter tube, and a shell defining a collection chamber. The filter tube includes a wall defining apertures, an inlet through which fluid and material enter the filter tube, protrusions extending inwardly from the wall of the filter tube, and an outlet through which the fluid and material exit the filter tube. The protrusions are in front of the apertures from a perspective of the inlet. Each annular structure of the plurality of annular structures defines an opening. The filter tube extends through the opening of each annular structure of the plurality of annular structures. Each annular structure of the plurality of annular structures configured to rotate about the filter tube. With the collector secured to the plurality of annular structures below the filter tube, the collector is maintained in a substantially horizontal orientation under the filter tube regardless of an orientation of the material collection device. The collector is configured to collect particles of the material that exit the filter tube through the apertures. The filter tube extends through the collection chamber. The collector is positioned within the collection chamber.

In some embodiments, a method of operating a placer recovery system includes coupling a collector to a plurality of annular structures spaced along a filter tube within a material collection device; intake, by a material intake device, material and fluid; delivering the material and the fluid from the material intake device to the material collection device; collecting first particles on the collector, the first particles sufficiently dense to exit the filter tube through one or more apertures having protrusions in front of the one or more apertures; discarding, through an outlet of the material collection device, second particles of the material; and rotating the collector to a substantially horizontal position under the filter tube responsive to a gravitational force acting on a mass of the collector.

In some embodiments, a placer recovery system includes a material intake device and a material collection device configured to receive material and fluid from the material intake device. The material collection device includes a filter tube and a collector. The collector is secured to a plurality of annular structures spaced along the filter tube to maintain the collector in a substantially horizontal orientation under the filter tube regardless of an orientation of the material collection device.

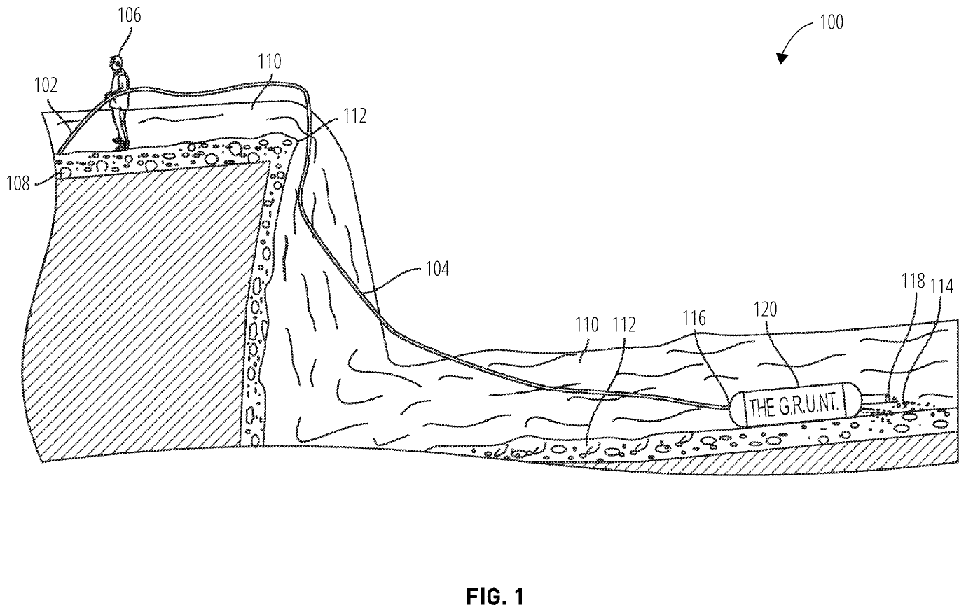

FIG. 1 is a side view of a placer recovery system 100, according to some embodiments. The placer recovery system 100 includes a material collection device 120, a material intake device 102, and a material transmission device 104. The material collection device 120 includes a filter tube (not shown in FIG. 1) extending therethrough, the filter tube including apertures and protrusions in front of the apertures from a perspective of an inlet 116 of the filter tube and a collector (not shown in FIG. 1) positioned below the filter tube, as will be discussed in more detail below. The material intake device 102 intakes material 108 from a streambed 112 or a river bed and fluid from a stream 110. The material transmission device 104 delivers the material 108 and fluid 410 (see FIG. 4) from the material intake device 102 to the material collection device 120. As used herein, the term “streambed” refers to a bottom or bed of any body of water including a stream, a river, a canal, a pond, a lake, a puddle, an ocean, or other body of water.

In operation, an operator 106 may utilize the material intake device 102 to intake the material 108 from the streambed 112, the material transmission device 104 may deliver the material 108 and fluid to the inlet 116 of the material collection device 120, and the material collection device 120 may collect desirable particles of the material 108, and discharge, from an outlet 118 of the material collection device 120, discarded material 114 including undesired materials of the material 108.

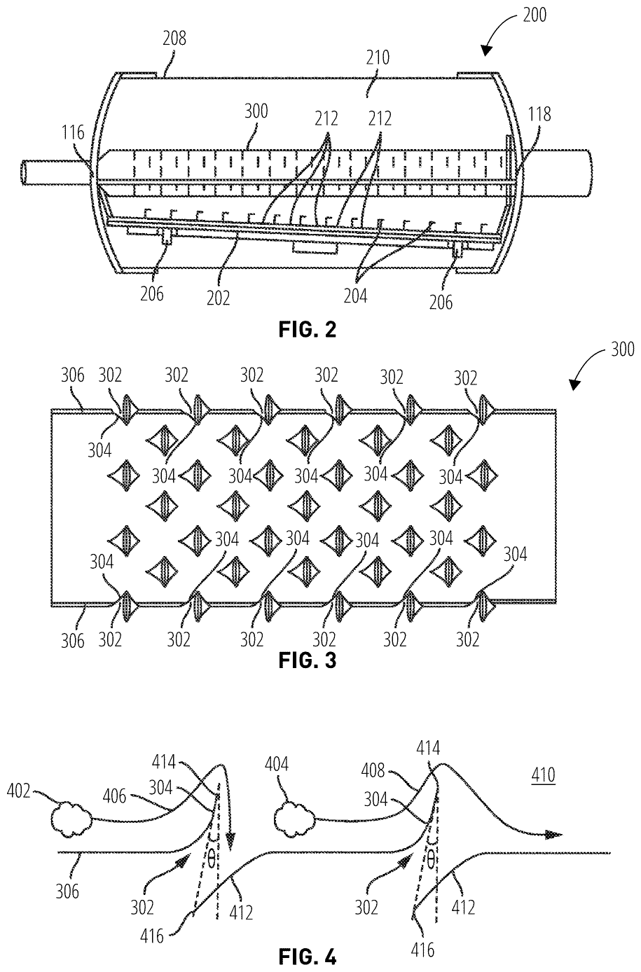

FIG. 2 is a side view of a material collection device 200, which is an example of a material collection device 120 of the placer recovery system 100 of FIG. 1, according to some embodiments. The material collection device 200 includes a shell 208, a filter tube 300, and a collector 202 positioned below the filter tube 300. By way of non-limiting example, a diameter of the shell 208 may be substantially twenty-four inches (24 in.). Also by way of non-limiting example, the shell 208 may be a plastic corrugated tube. The shell 208 defines a collection chamber 210.

The filter tube 300 extends through the collection chamber 210. By way of non-limiting example, the filter tube 300 may include a stainless steel tube. Also by way of non-limiting example, a diameter of the filter tube 300 may be substantially three inches (3 in.). The filter tube 300 includes an inlet 116 through which fluid and material enter the filter tube 300. The filter tube 300 also includes an outlet 118 through which the fluid and material exit the filter tube 300. FIG. 3 illustrates more detail regarding the filter tube 300. The collector 202 is positioned within the collection chamber 210 below the filter tube 300.

FIG. 3 is a side view of a portion of a filter tube 300 of the material collection device 200 of FIG. 2, according to some embodiments. The filter tube 300 includes a wall 306 defining apertures 302. The filter tube 300 also includes protrusions 304 extending inwardly from the wall 306 of the filter tube 300. The protrusions are positioned in front of the apertures 302 from a perspective of the inlet 116 (FIG. 1 and FIG. 2).

FIG. 4 is a zoomed-in side view of a sub-portion of the filter tube 300 of FIG. 3. FIG. 4 illustrates the wall 306, apertures 302 in the wall 306, and protrusions 304 extending inwardly from the wall 306 in front of the apertures 302. FIG. 4 also illustrates a first particle 402 and a second particle 404. The first particle 402 may be a denser particle than the second particle 404. By way of non-limiting example, the first particle 402 may be a gold particle, which is desired to be collected by the material collection device 200 (FIG. 2). Since the first particle 402 is denser than the second particle 404, the first particle 402 may have an exit path 406 that has a steeper descent following the protrusions 304 than a retention path 408 of the second particle 404. As a result, the first particle 402 may exit the filter tube 300 through one of the apertures 302, and the second particle 404 may be retained within the filter tube 300 until it reaches the outlet 118 and is discarded as discarded material 114 (FIG. 1).

In addition to the protrusions 304, which extend inwardly into the filter tube 300 (FIG. 3) from the wall 306, in some embodiments the filter tube 300 may also include outward protrusions 412, which may protrude outwards from the wall 306. The outward protrusions 412 may be positioned behind the apertures 302 from a perspective of the inlet 116 (FIG. 1). In some embodiments an angle θ between a line perpendicular to the wall 306 and a line from a tip 414 of one of the protrusions 304 to a tip 416 of a corresponding one of the outward protrusions 412 may be between 5° and 55°. By way of non-limiting example, the angle θ may be substantially 30°. Although not shown in FIG. 4, the angle θ may be substantially 0° (e.g., the line from the tip 414 to the tip 416 may be substantially perpendicular to the wall 306.

Returning to FIG. 2, the collector 202 is configured to collect particles (e.g., first particle 402 of FIG. 4) of the material 108 that exit the filter tube 300 through the apertures 302. The collector 202 may include ridges 204 on a top surface thereof to prevent collected particles that collect thereon from leaving the top surface. In some embodiments the collector 202 may include eddy features 212 formed therein instead of or in addition to the ridges 204 to induce eddies in the fluid within the collection chamber 210 proximate to the ridges 204. Such eddies may encourage particles leaving the filter tube 300 (e.g., through the apertures 302 of FIG. 3 and FIG. 4) to travel toward and rest on the collector 202 (e.g., on or in the ridges 204 and/or on or in the eddy features).

The collector 202 may also include rollers 206 configured to engage with an inner surface of the shell 208 to maintain the collector 202 in a substantially horizontal orientation (e.g., slightly slanted as shown in FIG. 2) under the filter tube 300 regardless of an orientation of the material collection device 200. In other words, the collector 202 is configured to remain below the filter tube 300 regardless of an orientation of the material collection device 200. As a result, if the material collection device 200 rolls around within a stream during operation, the collector 202 remains below the filter tube 300 and may continue to collect particles. Also, as illustrated in FIG. 3, the apertures 302 and their corresponding protrusions 304 are arranged substantially all around the wall 306 to enable the particles of the material to exit the filter tube 300 through the apertures 302 regardless of an orientation of the filter tube 300.

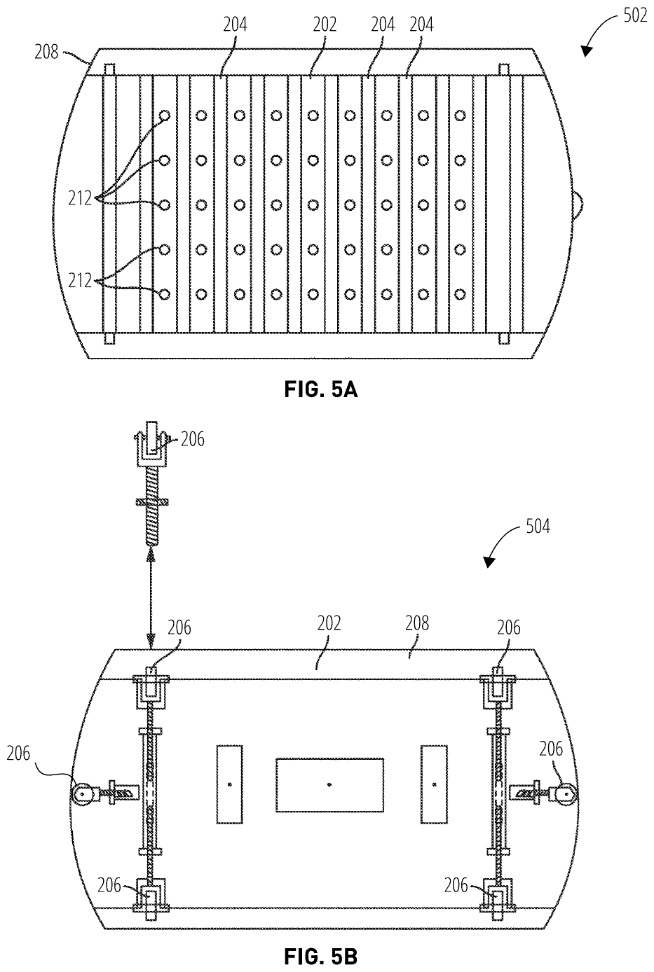

FIG. 5A illustrates a top view 502 of the collector 202 within the shell 208 of the material collection device 200 of FIG. 2, according to some embodiments.

FIG. 5B illustrates a bottom view 504 of the collector 202 within the shell 208 of the material collection device 200 of FIG. 2, according to some embodiments.

In some embodiments, the collector 202 includes a sluice box. By way of non-limiting example, the collector 202 may include a twelve inch (12 in.) sluice box. In some embodiments, the collector 202 may be positioned at between a substantially eight percent (8%) to fifteen percent (15%) grade. Referring to FIG. 5A and FIG. 5B together, the bottom view 504 shows the rollers 206, and the top view shows the ridges 204 and the eddy features 212. As illustrated in FIG. 5B, the rollers 206 may be secured to the collector 202 via threaded members, which may enable rotation of the threaded members to change a position of the rollers 206. In some embodiments the eddy features 212 may include swirl patterns therein to induce the fluid (e.g., the fluid 410 of FIG. 4) to eddy (e.g., to swirl around) responsive to the fluid passing over the eddy features 212.

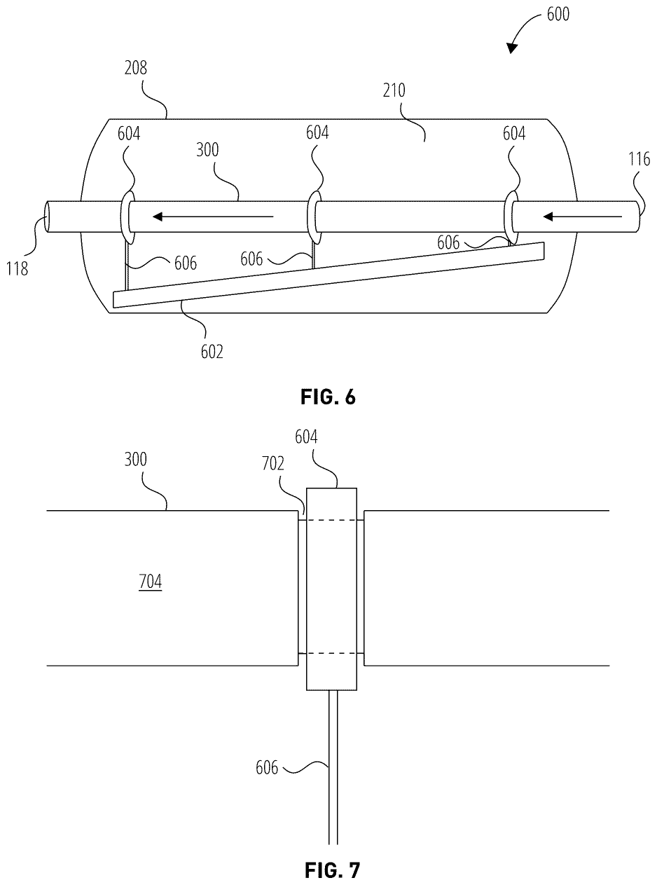

FIG. 6 is a side view of a material collection device 600, which is another example of a material collection device 120 of the placer recovery system 100 of FIG. 1, according to some embodiments. The material collection device 600 includes the shell 208 defining a collection chamber 210, as discussed with reference to FIG. 2. The material collection device 600 also includes the filter tube 300 discussed with reference to FIG. 3, that extends though the collection chamber 210. As previously discussed, the filter tube 300 includes a wall 306 defining apertures 302 (wall 306 and apertures 302 shown in FIG. 3 but not in FIG. 6 for simplicity), an inlet 116 through which fluid and material enter the filter tube 300, protrusions 304 (protrusions 304 shown in FIG. 3 but not in FIG. 6 for simplicity) extending inwardly from the wall 306 of the filter tube 300, and an outlet 118 through which the fluid and material exit the filter tube 300. The protrusions 304 are in front of the apertures 302 from a perspective of the inlet 116.

The material collection device 600 further includes a collector 602 positioned within the collection chamber 210. Although not shown in FIG. 6 for the sake of simplicity, the collector 602 may include the ridges 204 and the eddy features 212 discussed with reference to FIG. 2 and FIG. 5A. As discussed above for the material collection device 200 of FIG. 2, the rollers 206 maintain the collector 202 in a substantially horizontal orientation below the filter tube 300 regardless of an orientation of the material collection device 200. Rather than including the rollers 206 of the collector 202 of FIG. 2 and FIG. 5B to maintain the orientation of the collector 602 in an at least substantially horizontal position under the filter tube 300, the material collection device 600 instead includes a plurality of annular structures 604 spaced along the filter tube 300. By way of non-limiting example, the material collection device 600 may include three annular structures 604 spaced evenly along the filter tube 300.

Each annular structure 604 defines an opening, and the filter tube 300 extends through the opening of each annular structure 604. Also, each annular structure 604 is configured to rotate about the filter tube 300. By way of non-limiting example, the annular structures 604 may be free spinning about the filter tube 300 (e.g., the annular structures 604. The collector 602 is secured to each of the plurality of annular structures 604 by one or more line materials 606. By way of non-limiting examples, the one or more line materials 606 may include cables, wires, ropes, strings, straps, bands, other line materials, or combinations thereof. As a specific, non-limiting example, the one or more line materials 606 may include stainless steel wires of substantially five inches (5 in.) in length and one eighth inch (⅛ in.) in diameter. A mass of the collector 602 causes a gravitational force to rotate the collector 602 to a position below the filter tube 300 and maintain the collector 602 in a substantially horizontal orientation under the filter tube 300 regardless of an orientation of the material collection device 600. With the collector 602 below the filter tube 300, the collector 602 collects particles of material that exit the filter tube 300 through the apertures 302.

In some embodiments, each annular structure 604 may be held in position at a specific location along the filter tube 300 by a recess 702 made in an outer surface 704 of the filter tube 300. FIG. 7 illustrates an example of one of the annular structures 604 of FIG. 6 positioned in a recess 702 in the outer surface 704 of the filter tube 300. For example, an inner diameter of the opening of the annular structure 604 may be smaller than an outer diameter of the filter tube 300 except at the recess 702 to prevent the annular structure 604 from leaving the portion of the filter tube 300 that includes the recess 702. FIG. 7 also illustrates line material 606 configured to secure the collector 602 (FIG. 6) to the annular structure 604.

In some embodiments, recesses 702 may not be included in the outer surface 704 of the filter tube 300. In some such embodiments, the annular structure 604 may include a tab (e.g., tab 912 of FIG. 9) extending therefrom toward the filter tube 300. This tab may extend into the apertures 302 (FIG. 3) in the filter tube, which may prevent the annular structure 604 from sliding along the filter tube 300 to hold the annular structure 604 in position. The tab may be angled to enable rotation of the annular structure 604 around the filter tube 300 (e.g., to rotate from extending into one of the apertures 302 to another).

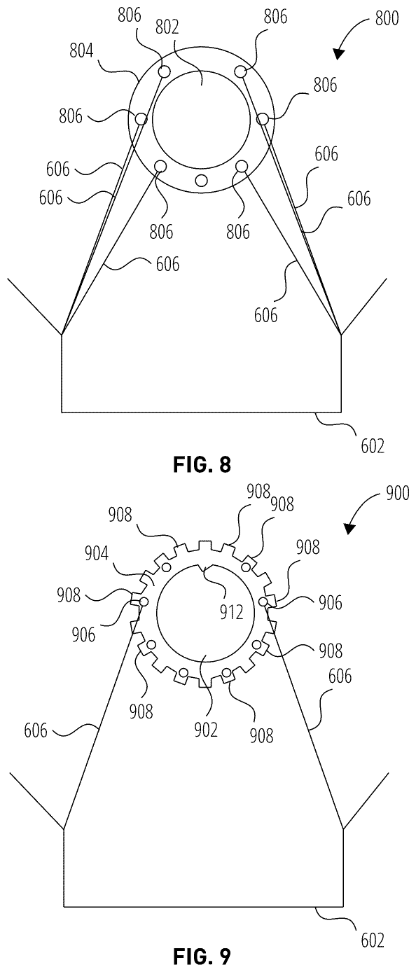

FIG. 8 is a front view of an example of a portion 800 of the material collection device 600 of FIG. 6. The portion 800 includes an annular structure 804, which is an example of the annular structure 604 of FIG. 6. The portion 800 also includes the collector 602 and some of the line materials 606 of FIG. 6. The line materials 606 couple the annular structure 804 to the collector 602. As previously discussed, the filter tube 300 (FIG. 3, FIG. 6) extends through the opening 802 defined by the annular structure 804.

In some embodiments, the annular structure 804 includes holes 806. The holes 806 may provide attachment points for coupling the line materials 606 to the annular structure 804. For example, attaching the line materials 606 to the annular structure 804 at the holes 806 may prevent the line materials 606 from slipping along the circumference of the annular structure 804. In the example of FIG. 8, each annular structure 604 may be connected to the collector 602 by six line materials 606.

FIG. 9 is a front view of another example of a portion 900 of the material collection device 600 of FIG. 6. The portion 900 includes an annular structure 904, which is an example of the annular structure 604 of FIG. 6. The portion 900 also includes the collector 602 and some of the line materials 606 of FIG. 6. The line materials 606 couple the annular structure 904 to the collector 602. As previously discussed, the filter tube 300 (FIG. 3, FIG. 6 (extends through the opening 902 defined by the annular structure 904.

In the example of FIG. 9, the annular structure 904 includes holes 906 similar to the holes 806 of the portion 800 of FIG. 8. The annular structure 904 also includes protrusions 908 extending outwardly from an outer surface of the annular structure 904. The protrusions 908, as well as the holes 906, may be used as attachment points for the line materials 606 to couple the collector 602 to the opening 902 and prevent the line materials 606 from sliding along the circumference of the opening 902.

The annular structure 904 also includes a tab 912 extending into the opening 902. With the filter tube 300 (FIG. 3, FIG. 6) extending through the opening 902, the tab 912 may extend into one of the apertures 302 (FIG. 3) of the filter tube 300. With the tab 912 extended into one of the apertures 302, the tab 912 may reduce the likelihood of the annular structure 904 sliding along the length of the filter tube 300.

The tab 912 is angled to enable the annular structure 904 to rotate around the filter tube 300 while resisting movement of the annular structure 904 along the length of the filter tube 300. For example, edges of the tab 912 may be angled to allow the tab 912 to exit the apertures 302 in a circumferential direction responsive to rotation of the annular structure 904 relative to the filter tube 300. The tab 912, however, may present an at least substantially planar surface at least substantially perpendicular to the outer surface of the filter tube 300 to reduce the likelihood that the tab 912 exits the apertures 302 in a longitudinal direction of the filter tube 300 responsive to forces pushing the annular structure 904 along the length of the filter tube 300.

Although the annular structure 904 of FIG. 9 includes only a single tab 912, in some embodiments, an annular structure may include multiple tabs. In such embodiments, the tabs may be spaced around the opening 902 to match spacing of the apertures 302 around the filter tube 300. As a result, multiple tabs may extend into multiple apertures 302 at once.

Also, although the annular structure 804 of FIG. 8 is not shown as including a tab similar to the tab 912, an annular structure similar to the annular structure 804 of FIG. 8 may include one or more tabs similar to the tab 912 of FIG. 9. Furthermore, it is contemplated that, in some embodiments, an annular structure similar to the annular structure 904 of FIG. 9 may not include a tab similar to the tab 912 of FIG. 9.

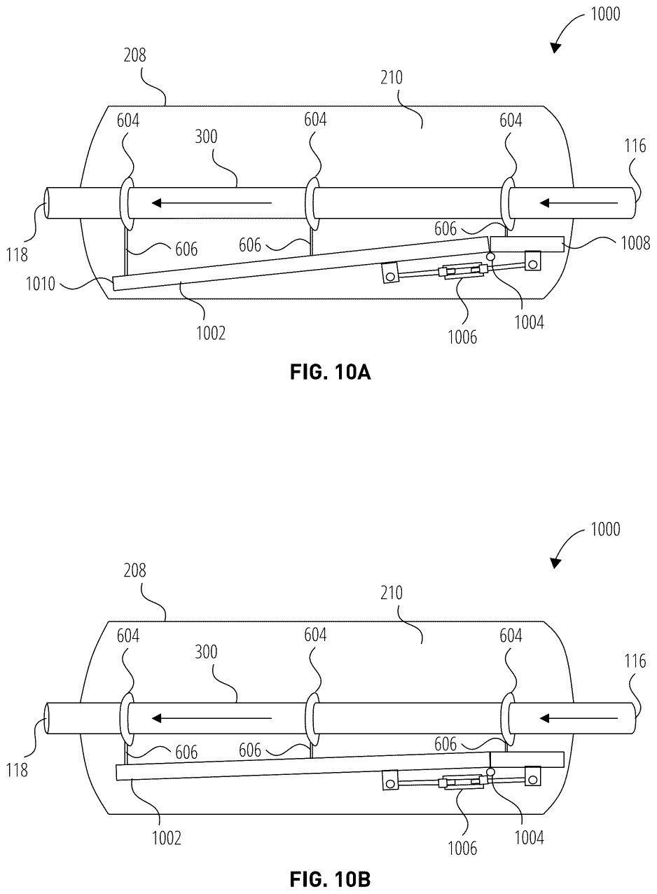

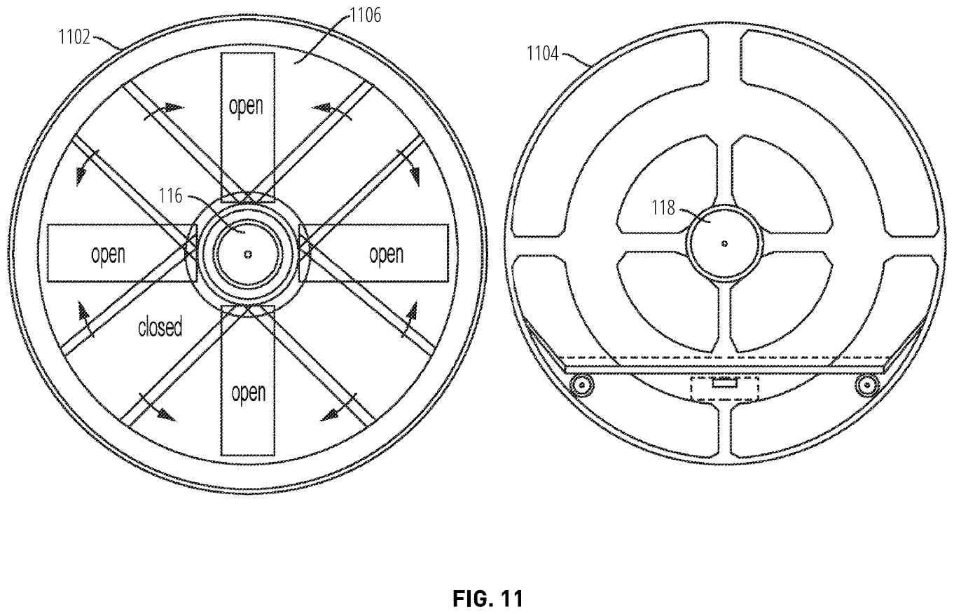

FIG. 10A and FIG. 10B are side views of another example of a material collection device 1000 including a hinged collector 1002. The material collection device 1000 includes the shell 208, the collection chamber 210, the filter tube 300 (including the inlet 116 and the outlet 118), the annular structures 604, and the line materials 606 discussed above with reference to FIG. 2, FIG. 3, and FIG. 6. Rather than including the collector 602 of FIG. 6, however, the material collection device 1000 includes a hinged collector 1002. The hinged collector 1002 is configured to be set at different angles relative to horizontal to increase (at relatively steeper angles) or decrease (at relatively shallower angles) the speed of fluid and material running down the hinged collector 1002.

The hinged collector 1002 includes a first portion 1008 closer to the inlet 116 and a second portion 1010 closer to the outlet 118. The hinged collector 1002 also includes one or more hinges 1004 connecting the first portion 1008 to the second portion 1010. The hinged collector 1002 further includes an adjustment mechanism 1006 configured to adjust an angle of the second portion 1010 relative to the first portion 1008. In the example illustrated in FIG. 10A and FIG. 10B, the adjustment mechanism 1006 includes a turnbuckle coupled between an underside of the first portion 1008 and an underside of the second portion 1010. The adjustment mechanism 1006 may be extended or shortened (e.g., by turning the turnbuckle) to decrease or increase, respectively, an angle of the second portion 1010 relative to the first portion 1008.

The material collection device 1000 illustrated in FIG. 10A shows the adjustment mechanism 1006 shortened to increase the angle of the second portion 1010 relative to the first portion 1008 compared to that shown in FIG. 10B. FIG. 10B shows the adjustment mechanism 1006 lengthened to decrease the angle of the second portion 1010 relative to the first portion 1008. Since the angle of the second portion 1010 in FIG. 10A relative to the first portion 1008 is steeper than the angle of the second portion 1010 in FIG. 10B relative to the first portion 1008, fluid and material running down the hinged collector 1002 in FIG. 10A would tend to move relatively faster than fluid and material running down the hinged collector 1002 in FIG. 10B. Accordingly, the hinged collector 1002 may enable control over how fast fluid and material travel down the hinged collector 1002.

FIG. 11 illustrates an inlet end 1102 and an outlet end 1104 of the material collection device 120 of FIG. 1, according to some embodiments. The inlet end 1102 may include a valve that may be opened or closed to allow or impede fluid (e.g., water) from the body of water to enter the collection chamber 210. The outlet end 1104 may allow fluid to exit the collection chamber 210. As a result, the fluid may flow through the material collection device 120. By way of non-limiting example, the material collection device 120 may be submerged in the fluid and a current of the body of water may move water through the material collection device 120. In some embodiments a mesh 1106 may be included behind the inlet end 1102 to prevent debris from entering the collection chamber 210 and resting on the collector 202 or interfering with the particles as they descend from the filter tube 300 toward the collector 202.

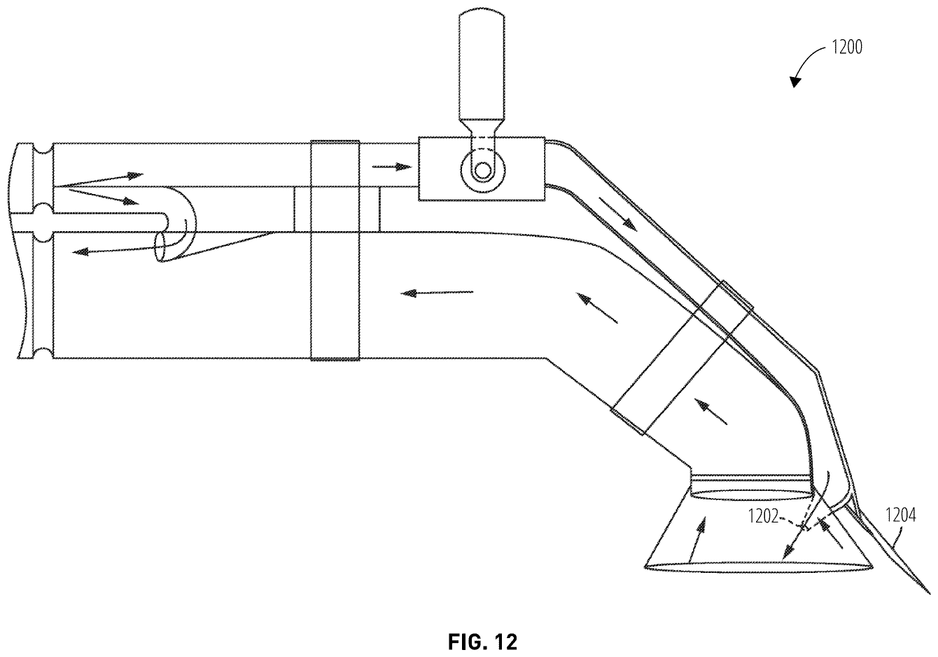

FIG. 12 is a material intake device 1200, which is an example of the material intake device 102 of FIG. 1, according to some embodiments. The material intake device 1200 includes a nozzle 1202 at an end thereof. The nozzle 1202 is configured to propel fluid into the streambed to dislodge the material (e.g., material 108 of FIG. 1) from the streambed. The material intake device 1200 also includes a dislodging tool at the end of the material intake device 1200. The material intake device 1200 is configured to dislodge the material from the streambed. By way of non-limiting example, the dislodging tool may include a spike 1204 configured for insertion into the streambed to enable an operator of the material intake device 102 to churn through the streambed with the spike 1204 to dislodge the material from the streambed.

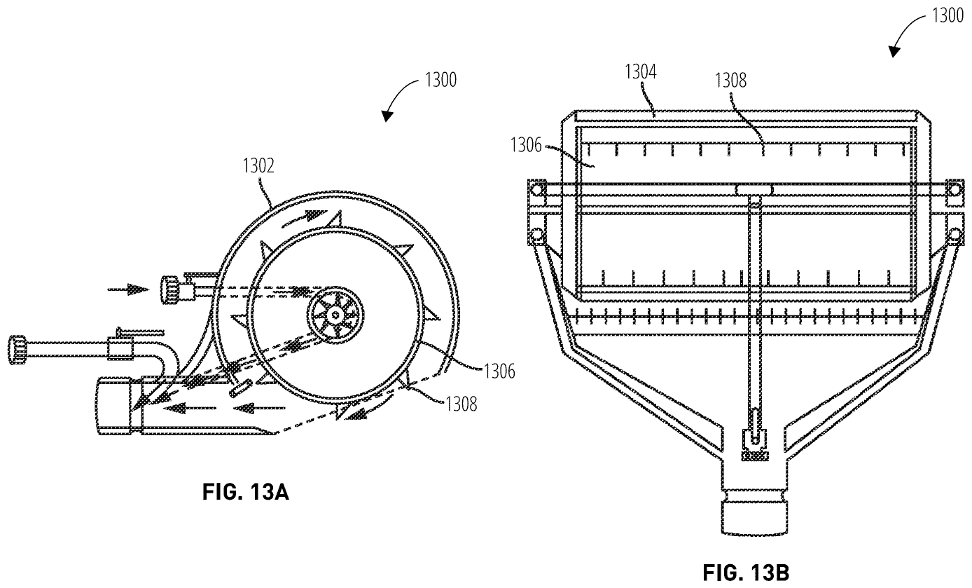

Other dislodging tools may be used at the end of the material intake device 102 in some embodiments. By way of non-limiting example, a dislodging tool may include a driven wheel having one or more teeth protruding therefrom. An example of a dislodging tool having a driven wheel and one or more teeth protruding therefrom is illustrated in FIG. 13A and FIG. 13B.

FIG. 13a illustrates a side view 1302 of a dislodging tool 1300, according to some embodiments.

FIG. 13B illustrates a bottom view 1304 of the dislodging tool 1300, according to some embodiments. Referring to FIG. 13A and FIG. 13B together, in some embodiments the dislodging tool 1300 may be positioned at the end of a material intake device such as the material intake device 102 of FIG. 1 to dislodge material (e.g., material 108 of FIG. 1) from a streambed (e.g., the streambed 112 of FIG. 1). The dislodging tool 1300 includes a wheel 1306 having teeth 1308. When the wheel 1306 is driven to spin (e.g., by fluid turning the wheel 1306 as illustrated by the side view 1302) the teeth 1308 dislodge material that the material intake device may intake.

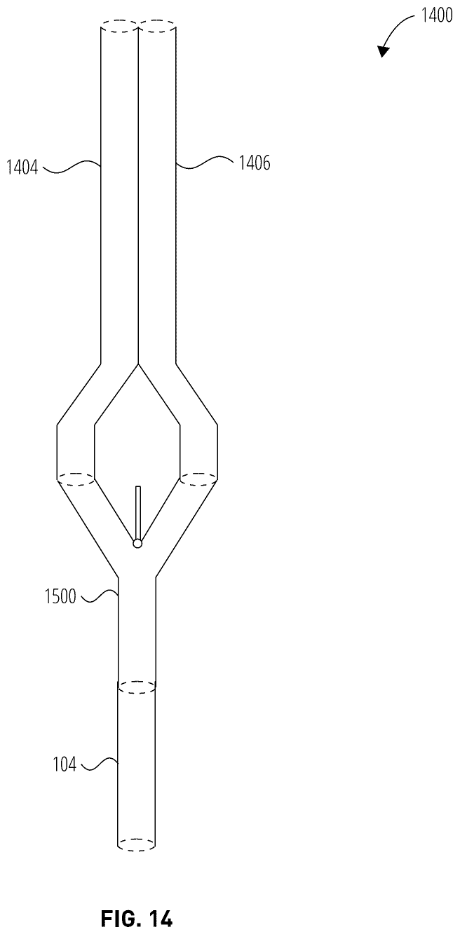

FIG. 14 is another example of a material intake device 1400, which may be used as the material intake device 102 of the placer recovery system 100 FIG. 1. The material intake device 1400 includes a first tube 1404, a second tube 1406, and a gated splitter 1500 selectively connecting the first tube 1404 or the second tube 1406 to the material transmission device 104. By way of non-limiting example, the first tube 1404 and the second tube 1406 may include three inch (3″) diameter tubes.

While operating the placer recovery system 100 (FIG. 1), large pieces of material may become lodged in the material intake device 1400, which may impede or completely block the flow of material and fluid to the material transmission device 104. The first tube 1404 and the second tube 1406 provide redundancy to provide another path for the material and fluid if one of the first tube 1404 or the second tube 1406 becomes obstructed.

The gated splitter 1500 is configured to selectively couple one of the first tube 1404 or the second tube 1406 to the material transmission device 104. Accordingly, the placer recovery system 100 may continue to operate despite an obstruction or even a complete clog in one of the first tube 1404 or the second tube 1406. The other of the first tube 1404 or the second tube 1406 may continue to operate while the clogged one of the first tube 1404 or the second tube 1406 is cleaned out.

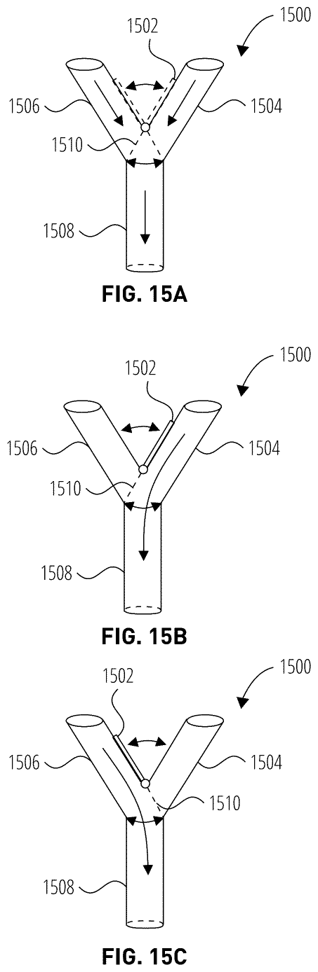

FIG. 15A, FIG. 15B, and FIG. 15C are side views of the gated splitter 1500 of the material intake device 1400 of FIG. 14. The gated splitter 1500 includes a first inlet 1506, a second inlet 1504, and a splitter outlet 1508. The gated splitter 1500 also includes a stopper 1510 controlled by a gate valve 1502. The gate valve 1502 may be moved to move the stopper 1510 to close off one of the first inlet 1506 or the second inlet 1504 and open up the other of the first inlet 1506 and the second inlet 1504. By way of non-limiting example, the diameters of the first inlet 1506, the second inlet 1504, and the splitter outlet 1508 may be three inches (3″).

For example, in FIG. 15B, the gate valve 1502 is positioned to cause the stopper 1510 to close off the first inlet 1506 and open the second inlet 1504. Accordingly, in this configuration, material and fluid may pass from the second tube 1406 (FIG. 14) through the second inlet 1504 and the splitter outlet 1508 to the material transmission device 104 (FIG. 14).

In FIG. 15C, the gate valve 1502 is positioned to cause the stopper 1510 to close off the second inlet 1504 and open the first inlet 1506. Accordingly, in this configuration, material and fluid may pass from the first tube 1404 (FIG. 14) through the first inlet 1506 and the splitter outlet 1508 to the material transmission device 104 (FIG. 14). As a result, in operation, if an operator of the placer recovery system 100 notices an obstruction in the flow of material and fluid, the operator may adjust the gate valve 1502 to switch to a different one of the first tube 1404 and the second tube 1406 (FIG. 14).

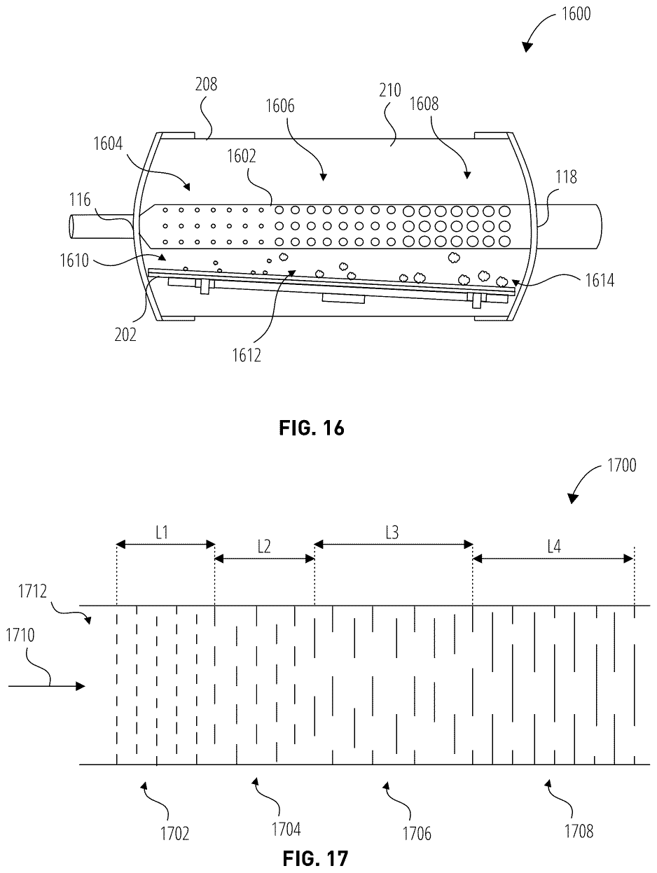

FIG. 16 is a side view of another example of a material collection device 1600. The material collection device 1600 includes the shell 208, the collection chamber 210, the collector 202, the inlet 116, and the outlet 118 discussed with reference to FIG. 1 and FIG. 2. In some embodiments, the material collection device 1600 may include the hinged collector 1002 of FIG. 10A instead of the collector 202. Also, rather than the filter tube 300 of FIG. 2 and FIG. 3, the material collection device 1600 includes a filter tube 1602 including apertures that vary in size. For example, the filter tube 1602 may include smallest apertures 1604 near the inlet 116, largest apertures 1608 near the outlet 118, and medium apertures 1606 in between. Although FIG. 16 illustrates three different sizes of apertures, the filter tube 1602 may include higher or lower numbers of sizes of apertures.

The positioning of the smallest apertures 1604 near the inlet 116, the largest apertures 1608 near the outlet 118, and the medium apertures 1606 in between may result in the smallest particles 1610 exiting the filter tube 1602 near the inlet 116, largest particles 1614 exiting the filter tube 1602 near the outlet 118, and medium particles 1612 exiting the filter tube 1602 in between. Accordingly, the smallest particles 1610 may tend to gather on the collector 202 near the inlet 116, the largest particles 1614 may tend to gather on the collector 202 near the outlet 118, and the medium apertures 1606 may tend to gather on the collector 202 in between. As a result, if particles transition down the collector 202 (e.g., due to gravity and/or flow of fluid), the smaller particles bumping into larger particles located downhill from the smaller particles on the collector 202 may be less likely to dislodge the larger particles from the collector 202 than larger particles would be if they traveled down the collector 202 and bumped into smaller particles. In other words, the placement of smaller apertures near the inlet 116 and larger apertures near the outlet 118 may reduce the chances of particles dislodging other particles from the medium particles 1612 as they transition down the collector 202.

FIG. 17 is simplified side view of a portion of a filter tube 1700, which is an example of the filter tube 1602 of the material collection device 1600 of FIG. 16. The filter tube 1700 includes a first portion 1702 having a length L1, a second portion 1704 having a length L2, a third portion 1706 having a length L3, and a fourth portion 1708 having a length L4. By way of non-limiting example, length L1 may be one half an inch (½ in.), length L2 may be one inch (1 in.), length L3 may be one and one half inch (1 ½ in.), and length L4 may be two inches (2 in.).

The filter tube 1700 includes apertures 1712 formed therein. As discussed with reference to the apertures (e.g., the smallest apertures 1604, the medium apertures 1606, and the largest apertures 1608) of the filter tube 1602 of FIG. 16, the apertures 1712 may vary in size along a length of the filter tube 1700. For example, those of the apertures 1712 in the first portion 1702 may be smaller than those of the apertures 1712 in the second portion 1704, the third portion 1706, and the fourth portion 1708. Also, those of the apertures 1712 that are within the second portion 1704 may be smaller than those of the apertures 1712 that are in the third portion 1706 and the fourth portion 1708, but larger than those of the apertures 1712 in the first portion 1702. Those of the apertures 1712 in the third portion 1706 may be smaller than those of the apertures 1712 in the fourth portion 1708, but larger than those of the apertures 1712 in the first portion 1702 and the second portion 1704. Those of the apertures 1712 in the fourth portion 1708 may be larger than those of the apertures 1712 in the first portion 1702, the second portion 1704, and the fourth portion 1708.

Material and fluid 1710 may enter the filter tube 1700 and pass through the filter tube 1700 from the first portion 1702 to the second portion 1704, from the second portion 1704 to the third portion 1706, and from the third portion 1706 to the fourth portion 1708. Since the apertures 1712 progressively increase in size as the material and fluid 1710 flow through the filter tube 1700, the size of particles exiting through the apertures 1712 may increase, on average, along the length of the filter tube 1700, as discussed with reference to FIG. 16. Accordingly, a collector (e.g., the collector 202 of FIG. 16) may tend to accumulate smaller particles near the inlet (e.g., the inlet 116 of FIG. 6) of the filter tube 1700 and larger particles near the outlet (e.g., the outlet 118 of FIG. 16), which may reduce the chances of larger particles flowing downstream along the collector and dislodging smaller particles.

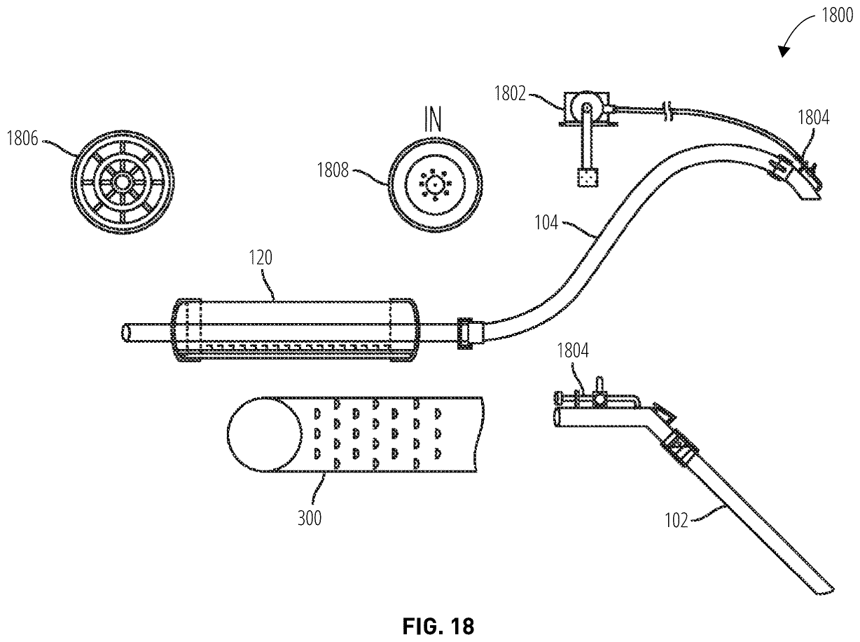

FIG. 18 is a side view of a placer recovery system 1800, which is an example of the placer recovery system 100 of FIG. 1 implementing a water pump 1802. The placer recovery system 1800 includes the material collection device 120, the filter tube 300, the material transmission device 104, and the material intake device 102 discussed above with reference to FIG. 1. The placer recovery system 1800 also includes an outlet end 1806 and an inlet end 1808 for the material collection device 120. The outlet end 1806 and the inlet end 1808 are similar to the outlet end 1104 and the inlet end 1102 discussed with reference to FIG. 11.

The placer recovery system 1800 also includes a pump connector 1804 configured to connect to the water pump 1802. The water pump 1802 may in some embodiments drive the flow of fluid and material through the placer recovery system 1800. In such embodiments the water pump 1802 may be configured to move the material and the fluid through the filter tube 300 of the material collection device 120. In some embodiments naturally occurring current flowing through the material collection device 120 may drive the flow of fluid through a placer recovery system 100 in addition to or instead of the water pump 1802. By way of non-limiting example, the material intake device 102 may be used upstream from the material collection device 120 and current operating on the material collection device 120 may create suction in the material transmission device 104, similar to siphoning of gasoline from a gas tank.

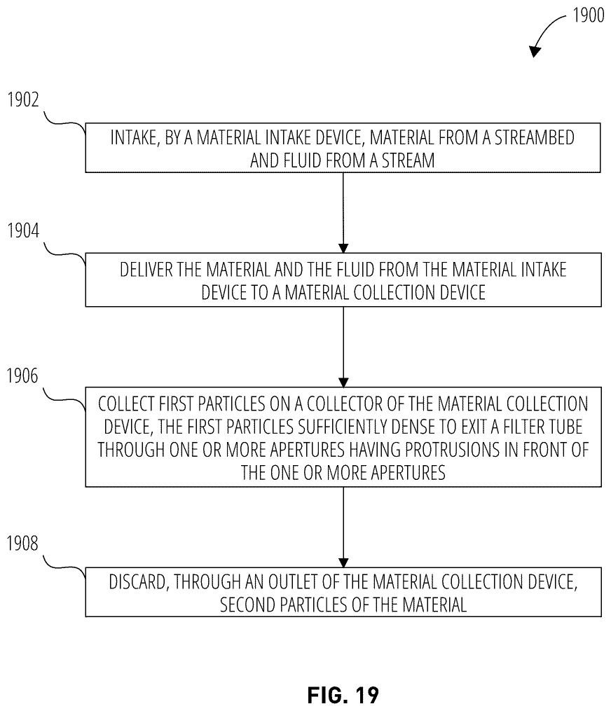

FIG. 19 is a flowchart illustrating a method 1900 of operating a placer recovery system, according to some embodiments. In operation 1902, method 1900 includes intaking, by a material intake device, material from a streambed and fluid from a stream. In operation 1904, method 1900 includes delivering the material and the fluid from the material intake device to a material collection device. In operation 1906, method 1900 includes collecting first particles on a collector of the material collection device, the first particles sufficiently dense to exit a filter tube through one or more apertures having protrusions in front of the one or more apertures. In operation 1908, method 1900 includes discarding, through an outlet of the material collection device, second particles of the material.

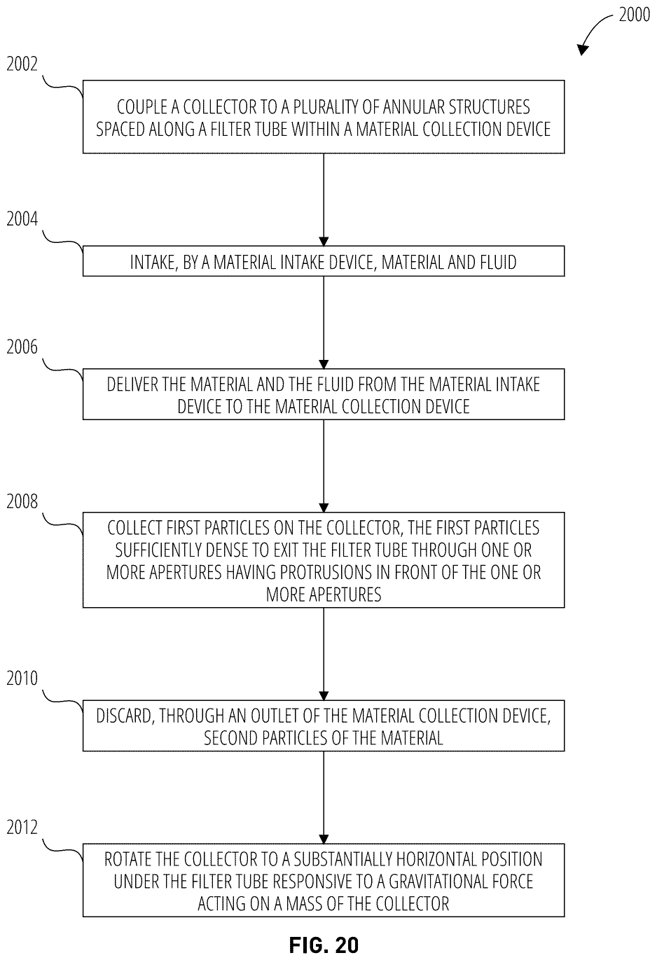

FIG. 20 is a flowchart illustrating another method 2000 of operating a placer recovery system, according to some embodiments. At operation 2002, the method 2000 includes coupling a collector (e.g., the collector 602 of FIG. 6) to a plurality of annular structures (e.g., the annular structures 604 of FIG. 6, the annular structures 804 of FIG. 8, the annular structures 904 of FIG. 9) spaced along a filter tube (e.g., the filter tube 300 of FIG. 3 and FIG. 6) within a material collection device (e.g., the material collection device 600 of FIG. 6). In some embodiments, coupling the collector to the plurality of annular structures includes coupling the collector to the plurality of annular structures with one or more line materials (e.g., the line materials 606 of FIG. 6, FIG. 7, FIG. 8, and FIG. 9). In some embodiments, the one or more line materials include one or more stainless steel wires. In some embodiments, a diameter of the one or more stainless steel wires is substantially one eight of an inch (⅛ in.). In some embodiments, the method 2000 includes spacing the annular structures evenly along the filter tube. In some embodiments, the method 2000 includes holding the plurality of annular structures in position with a plurality of recesses (e.g., the recess 702 of FIG. 7) in an outer surface (e.g., the outer surface 704 of FIG. 7) of the filter tube.

At operation 2004, the method 2000 includes intaking, by a material intake device (e.g., the material intake device 102 of FIG. 1, the material intake device 1200 of FIG. 12), material and fluid. At operation 2006, the method 2000 includes delivering the material and the fluid from the material intake device to the material collection device. At operation 2008, the method 2000 includes collecting first particles (e.g., first particle 402 of FIG. 4) on the collector. The first particles are sufficiently dense to exit the filter tube through one or more apertures (e.g., the apertures 302 of FIG. 3 and FIG. 4) having protrusions (e.g., the protrusions 304 of FIG. 3 and FIG. 4) in front of the one or more apertures. At operation 2010, the method 2000 includes discarding, through an outlet (e.g., outlet 118 of FIG. 1 and FIG. 6) of the material collection device, second particles (e.g., second particle 404 of FIG. 4) of the material. At operation 2012, the method 2000 includes rotating the collector to a substantially horizontal position under the filter tube responsive to a gravitational force acting on a mass of the collector.

As used in the present disclosure, the term “combination” with reference to a plurality of elements may include a combination of all the elements or any of various different sub-combinations of some of the elements. For example, the phrase “A, B, C, D, or combinations thereof” may refer to any one of A, B, C, or D; the combination of each of A, B, C, and D; and any sub-combination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

While the present disclosure has been described herein with respect to certain illustrated embodiments, those of ordinary skill in the art will recognize and appreciate that the present invention is not so limited. Rather, many additions, deletions, and modifications to the illustrated and described embodiments may be made without departing from the scope of the invention as hereinafter claimed along with their legal equivalents. In addition, features from one embodiment may be combined with features of another embodiment while still being encompassed within the scope of the invention as contemplated by the inventor.

What is claimed is:

1. A material collection device, comprising:
a filter tube including:
a wall defining apertures;
an inlet through which fluid and material enter the filter tube;
protrusions extending inwardly from the wall of the filter tube, the protrusions in front of the apertures from a perspective of the inlet; and
an outlet through which the fluid and material exit the filter tube;
a plurality of annular structures spaced along the filter tube, each annular structure of the plurality of annular structures defining an opening, the filter tube extending through the opening of each annular structure of the plurality of annular structures, each annular structure of the plurality of annular structures configured to rotate about the filter tube;
a collector secured to the plurality of annular structures below the filter tube to maintain the collector in a substantially horizontal orientation under the filter tube regardless of an orientation of the material collection device, the collector configured to collect particles of the material that exit the filter tube through the apertures; and
a shell defining a collection chamber, the filter tube extending through the collection chamber, the collector positioned within the collection chamber.

2. The material collection device of claim 1, wherein the collector is secured to the plurality of annular structures by one or more line materials.

3. The material collection device of claim 2, wherein each annular structure of the plurality of annular structures includes one or more holes to provide attachment points for coupling one or more line materials of the plurality of line materials to the annular structure.

4. The material collection device of claim 2, wherein each annular structure of the plurality of annular structures includes protrusions extending outwardly from an outer surface of the annular structure.

5. The material collection device of claim 2, wherein the one or more line materials include at least six line materials for each annular structure of the plurality of annular structures.

6. The material collection device of claim 2, wherein the one or more line materials include stainless steel wires.

7. The material collection device of claim 6, wherein the stainless steel wires have a diameter of substantially one eighth of an inch (⅛ in.).

8. The material collection device of claim 1, wherein the plurality of annular structures is spaced evenly along the filter tube.

9. The material collection device of claim 1, further comprising a material intake device including a first tube, a second tube, and a gated splitter configured to enable a user to selectively use either the first tube or the second tube for intake of the fluid and material.

10. The material collection device of claim 1, wherein at least one annular structure of the plurality of annular structures includes a tab extending therefrom toward the filter tube, the tab configured to may extend into one of the apertures to prevent the annular structure from sliding along the filter tube.

11. The material collection device of claim 1, wherein the collector includes one or more hinges and an adjustment mechanism configured to enable adjustment of an angle of at least a portion of the collector relative to horizontal.

12. A method of operating a placer recovery system, the method comprising:
coupling a collector to a plurality of annular structures spaced along a filter tube within a material collection device;
intake, by a material intake device, material and fluid;
delivering the material and the fluid from the material intake device to the material collection device;
collecting first particles on the collector, the first particles sufficiently dense to exit the filter tube through one or more apertures having protrusions in front of the one or more apertures;
discarding, through an outlet of the material collection device, second particles of the material; and
rotating the collector to a substantially horizontal position under the filter tube responsive to a gravitational force acting on a mass of the collector.

13. The method of claim 12, wherein coupling the collector to the plurality of annular structures includes coupling the collector to the plurality of annular structures with one or more line materials.

14. The method of claim 13, wherein the one or more line materials include one or more stainless steel wires.

15. The method of claim 14, wherein a diameter of the one or more stainless steel wires is substantially one eight of an inch (⅛ in.).

16. The method of claim 12, further comprising spacing the annular structures evenly along the filter tube.

17. The method of claim 12, further comprising holding the plurality of annular structures in position with tabs extending from the plurality of annular structures toward the filter tube.

18. A placer recovery system, comprising:
a material intake device; and
a material collection device configured to receive material and fluid from the material intake device, the material collection device including a filter tube and a collector, the collector secured to a plurality of annular structures spaced along the filter tube to maintain the collector in a substantially horizontal orientation under the filter tube regardless of an orientation of the material collection device.

19. The placer recovery system of claim 18, wherein the collector is secured to the plurality of annular structures using line materials.

20. The placer recovery system of claim 18, wherein those of the apertures near the inlet are smaller than those of the apertures near the outlet.
